(19) United States
(12) Patent Application Publication
(10) Pub. No.: US 2008/0010069 A1
(43) Pub. Date: Jan. 10, 2008

(54) Authoring and running speech related applications

(75) Inventors: Sanjeev Katariya, Bellevue, WA (US); William D. Ramsey, Redmond, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/483,946

(22) Filed: Jul. 10, 2006

(51) Int. Cl. G10L 15/18

(52) U.S. Cl. 704/257

(57) ABSTRACT

A semantic and speech component provides a user interface for interaction with a user or author, and handles interactions with speech subsystems and semantic subsystems, so the user or author is not required to know the idiosyncrasies of each of those subsystems.

### BACKGROUND

Currently, many major research institutions are investing large amounts of resources into developing a machine understanding system, in which a computer can understand spoken language. Such a system requires accurate transcription of speech into text (i.e., accurate speech recognition), semantic understanding of the recognized speech, as well as dialog management to disambiguate meanings in the recognized speech and to gather additional information required to develop a full understanding of the speech. Each of these three requirements presents different hurdles. Yet, a comprehensive machine understanding system will have all three of these components, rendering it highly complicated.

Despite the difficulties associated with these technologies, there remain a relatively large number of practical uses for machine understanding systems. Such uses might include call centers which might take a speech input from a caller, such as “I have a problem with my printer” and route that call to the appropriate person. Such uses might also include front-end systems for large companies which might take a speech input such as “I want to book a flight from Boston to Seattle” and walk the caller through a reservation system in order to accomplish the flight scheduling task. Still another use might include interacting with a personal computer, such as providing a speech input “Please send email to John Doe.”

In attempting to develop such systems in the past, the acoustic speech recognition problem (converting speech into text), the semantic understanding problem, and the dialog management problem, have conventionally been treated independently. There is not believed to be any current authoring process (i.e., the process of creating a speech related application) that links the various technology areas together. This has required developers to learn the idiosyncrasies of the various subsystems (e.g., speech recognition, semantic understanding and dialog management) thereby making it difficult to deploy robust and scaleable speech related applications.

The discussion above is merely provided for general background information and is not intended to be used as an aid in determining the scope of the claimed subject matter.

### SUMMARY

A semantic and speech component provides a user interface for interaction with a user or author, and handles interactions with speech subsystems and semantic subsystems, so the user or author is not required to know the idiosyncrasies of each of those subsystems. In one embodiment, the semantic and speech component includes an authoring component that provides a user interface to an author, and handles all interactions with the speech and semantic subsystems required to author a speech related application. In another embodiment, the semantic and speech component includes a runtime component that provides an interface for interacting with a user of the speech related application. In that embodiment, the semantic and speech component handles all interactions with the speech and semantic subsystems during application runtime.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of a semantic/speech system in accordance with one embodiment.

FIG. 2A is a flow diagram illustrating how the system of FIG. 1 receives prompts and responses and generates grammars.

FIG. 2B is a graphical illustration corresponding to the flow diagram shown in FIG. 2A.

FIG. 3A is a flow diagram illustrating how the system shown in FIG. 1 operates to define tasks with associated grammars and dialogs.

FIGS. 3B-3G are graphical illustrations corresponding to the flow diagram of FIG. 3A.

FIG. 4 is a flow diagram illustrating how the system of FIG. 1 binds tasks or dialogs to runtime methods.

FIG. 5 is a flow diagram illustrating how the system shown in FIG. 1 generates confirmations with associated responses and grammars.

FIG. 6A is a flow diagram illustrating one exemplary runtime operation of the system shown in FIG. 1.

FIGS. 6B-6E are graphical illustrations corresponding to the flow diagram of FIG. 6A.

FIG. 7A is a flow diagram illustrating one exemplary dialog management operation.

FIGS. 7B-7H are graphical illustrations corresponding to the flow diagram shown in FIG. 7A.

FIG. 8 is a block diagram of one illustrative computing environment in which the present invention can be used.

### DETAILED DESCRIPTION

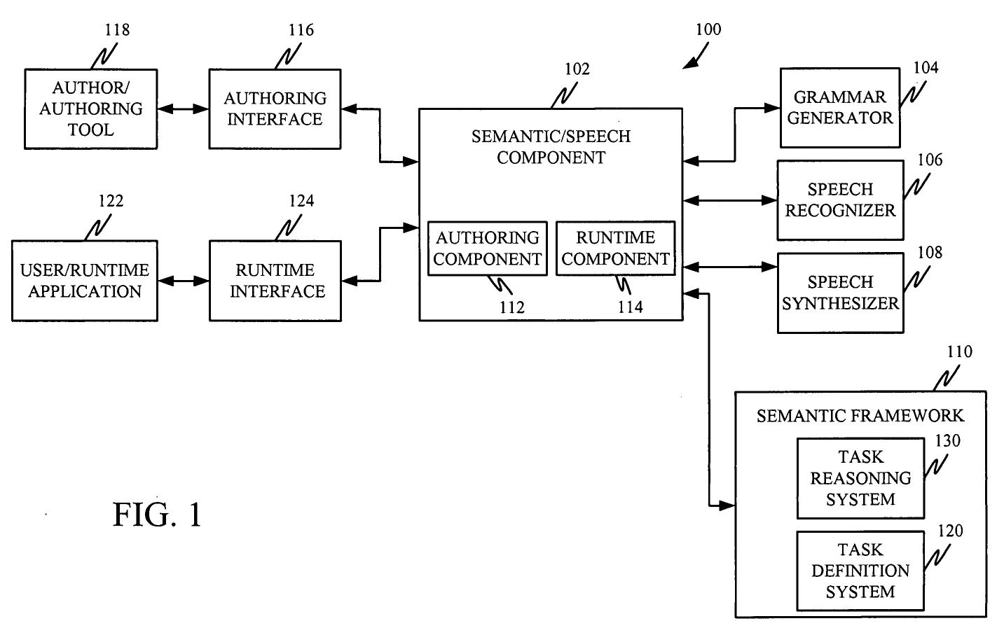

FIG. 1 is one exemplary block diagram of a speech authoring and runtime system 100. System 100 illustratively includes semantic/speech component 102 coupled to a plurality of speech and semantic subsystems. In the embodiment shown in FIG. 1, those subsystems include grammar generator 104, speech recognizer 106, speech synthesizer 108 and semantic framework 110.

Semantic/speech component 102 illustratively includes authoring component 112 and runtime component 114. During authoring of a speech related application, authoring component 112 illustratively generates an authoring interface 116 (such as an application programming interface API or a graphical user interface GUI) that is provided to an author or authoring tool 118. The author or authoring tool communicates with authoring component 112 through the authoring interface 116 in order to develop a speech related application, such as a dialog system.

In order to accomplish the desired functionality of the speech related application, the author will often be required to input prompts and associated expected user responses, along with tasks, dialogs, possibly cascaded dialogs and confirmations. Each of these is described in greater detail below. Suffice it to say, for now, that authoring component 112 takes these inputs through authoring interface 116 and provides certain portions of them to grammar generator 104 which generates grammars corresponding to the expected responses and dialog slot inputs. Authoring component 112 also interacts with task definition system 120 to further define the tasks based on the information input through authoring interface 116, by the author or authoring tool 118. Authoring is described in greater detail below.

Once the speech related application has been authored. It can be run in system 100 as a runtime application 122. Runtime component 114 in semantic/speech component 102 interacts with grammar generator 104 such that grammar generator 104 compiles the grammars necessary for runtime application 122. Those grammars are loaded into speech recognizer 106 by runtime component 114.

Runtime component 114 also generates a runtime interface 124 (such as an API or GUI) that is exposed to runtime application 122 (or a user of application 122) such that runtime information can be input to runtime component 114 in semantic/speech component 102. Based on the runtime inputs, runtime component 114 may access speech recognizer 106 to recognize input speech, or it may access speech synthesizer 108 to generate audible prompts to the user. Similarly, runtime component 114 illustratively accesses task reasoning system 130 in semantic framework 110 to identify tasks to be completed by runtime application 122, and to fill slots in those tasks and also to conduct dialog management in order to accomplish those tasks.

It can thus be seen that a user or author simply needs to interact with semantic/speech component 102 through an appropriate runtime interface 124 or authoring interface 116. The user or author need not know the intricate operation of the semantic subsystems and speech subsystems in order to either author, or run, a speech related application. Instead, the author illustratively communicates with component 102 in terms of familiar concepts (some of which are set out below) that are used in the application, and component 102 handles all the detailed communication with the subsystems. The detailed communication and interaction with the subsystems is illustratively done independently of the author in that the author does not need to expressly specify those interactions. In fact, the author need not even know how to specify those interactions.

It will also be noted that the semantic and speech subsystems listed in FIG. 1 are exemplary only. The invention is not to be limited to those subsystems, but could be used with other or different subsystems as well. A brief description of each of the subsystems will now be provided, although it will be recognized that the present invention does not rely on any given subsystems, and therefore the description of the subsystems is exemplary only.

Grammar generator 104 is illustratively any grammar generator that generates a grammar from a textual input. In one embodiment, grammar generator 104 generates speech recognition grammars from input sentences. There are numerous commercially available grammar generators.

Speech recognizer 106 is illustratively any desired speech recognition engine that performs acoustic speech recognition using a grammar supplied by the grammar generator 104 to specify the range of what can be recognized. Thus, speech recognizer 106 may include acoustic models, language models, a decoder, etc. There are numerous commercially available speech recognizers.

Speech synthesizer 108 is illustratively any desired speech synthesizer that receives a textual input and generates an audio output based on the textual input. There are numerous commercially available text to speech systems that are capable of synthesizing speech given a phrase. Speech synthesizer 108 may illustratively be suitable for providing a speech output from the textual input, via a telephone.

Semantic framework 110 can also be any desired semantic framework that receives text and provides a list of the most likely tasks and then, for each likely task, fills in the appropriate slots or parameters within the task, based on the input provided. Semantic framework 110 illustratively fills slots in a mixed initiative system, allowing users to specify multiple slot values at the same time, even when they are not yet requested, although this is not required by the present invention. Semantic framework 110 also illustratively includes a task reasoning system that conducts dialog management given a textual input and that operates to bind to external methods under desired circumstances, as described in greater detail below.

Because component 102 handles all of the interaction with the speech and semantic subsystems, this allows authors, or developers, to develop applications by coding against concepts that they are familiar with, such as user responses, application methods and business logic. The specifics of how this information is recognized, how it is fed downstream within the system, when confirmations are fired and what grammars are loaded, is all handled by system 102, so that the developer need not have detailed information in that regard.

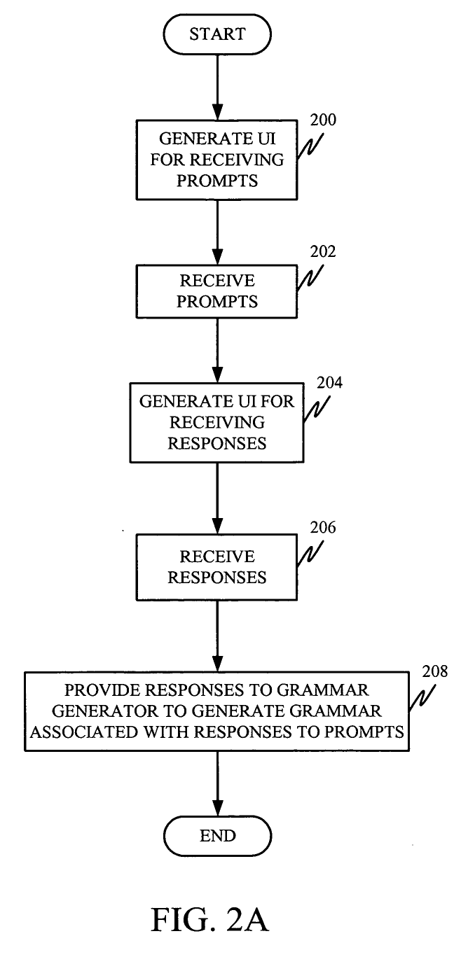

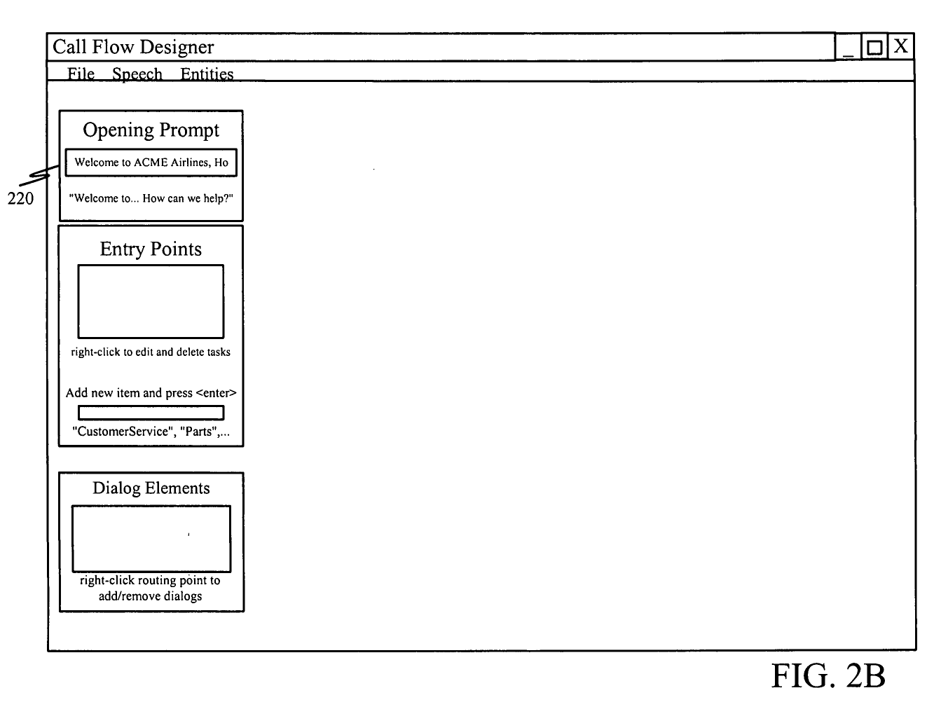

FIG. 2 is a flow diagram illustrating the operation of system 100 during a portion of the authoring process. In authoring the speech related application, the author will have knowledge related to the application, and the author will use component 102 to construct a set of functionality that can be understood by system 102 in order to implement the application. Assume, for the sake of example, that an author wishes to create a speech related server application for booking flight reservations on an airline. In that example, there are several pieces of information which the author supplies, through authoring interface 116, to the authoring component 112 in semantic/speech component 102.

One of those pieces of information is an opening prompt and the expected responses to that prompt. Therefore, FIG. 2A first indicates that the authoring component 112 in semantic/speech component 102 generates an authoring user interface 116 configured to receive, from the author, the opening prompt. This is indicated by block 200 in FIG. 2A. The author then provides that prompt, such as by typing it into a field on the user interface, or speaking it. Receiving the prompt through authoring interface 116 is indicated by block 202 in FIG. 2A.

FIG. 2B is one graphical illustration of an authoring interface 116 that is configured to receive the opening prompt. In the upper left corner of the screen, a text box 220, labeled “Opening Prompt” is provided such that the user can simply type the opening prompt into text box 220. It can be seen in FIG. 2B that the user has entered, as the opening prompt: “Welcome to ACME Airlines. How can we help?”

Component 212 then illustratively generates a user interface for receiving likely responses to the opening prompt. This is indicated by block 204, and receiving those responses from the author is indicated by block 206. Likely responses are those responses that the author expects a user (at runtime) to enter in response to the prompt. In one illustrative embodiment, a text box is provided such that the user can simply write in expected responses to the opening prompt.

The responses can then be provided by authoring component 112 (or, as described later, by runtime component 114) to grammar generator 104 to generate grammars associated with the responses to the opening prompt. This is indicated by block 208 in FIG. 2A. It will be noted, of course, that providing the responses to grammar generator 104 can be done either immediately, or at runtime, or at any time between receiving the responses and running the application. It is only necessary that the grammars be available to speech recognizer 106 during execution of the application at runtime.

In accordance with the example being discussed, it is implicit in creating a speech related server application that there is some task that the developer wants users to be able to do, such as booking a flight, checking flight status, or talking to a human operator. In order to accomplish some of these tasks, additional parameters are required, such as a flight number. However, some of these tasks may simply be performed directly, with no additional information.

The developer or author thus illustratively creates at least one task which can be reasoned over by the semantic framework 110. The task my have one or more semantic slots that must be filled to accomplish the task. Table 1 is an example of one exemplary task which is for booking a flight on an airline. The task shown in FIG. 1 has two semantic slots which are of a type “City”.

```
TABLE 1
    <Task Name=“BookFlight” Title= “Buy Tickets” Description=“Make
flight reservations”>
      <Keywords>flights;tickets;reservations </Keywords>
      <Slots>
        <Slot name=“Arrival” type=“City”>
          <PreIndicators>to, going into</PreIndicators>
          <PostIndicators>arrival city</PostIndicators>
        </Slot>
        <Slot name=“Departure” type=“City”>
          <PreIndicators>from, originating in</PreIndicators>
          <PostIndicators>departure city</PostIndicators>
        </Slot>
      </Slots>
      <Recognizer type=“City”>
        Atlanta;Austin;Boston;...;Washington;...
      </Recognizer>
    </Task>
```

The first slot is the arrival city and the second slot is the departure city. The task shown in Table 1 gives the task name and description, along with key words that may be used to identify this as a relevant task, given an input at runtime. The slots are then defined with pre-indicators and post-indicators that are words that may precede or follow the words that fill the slots. The task defined in Table 1 also identifies a recognizer grammar that will be loaded into the speech recognizer when this task is being performed. The recognizer grammar in Table 1 is a list of city names.

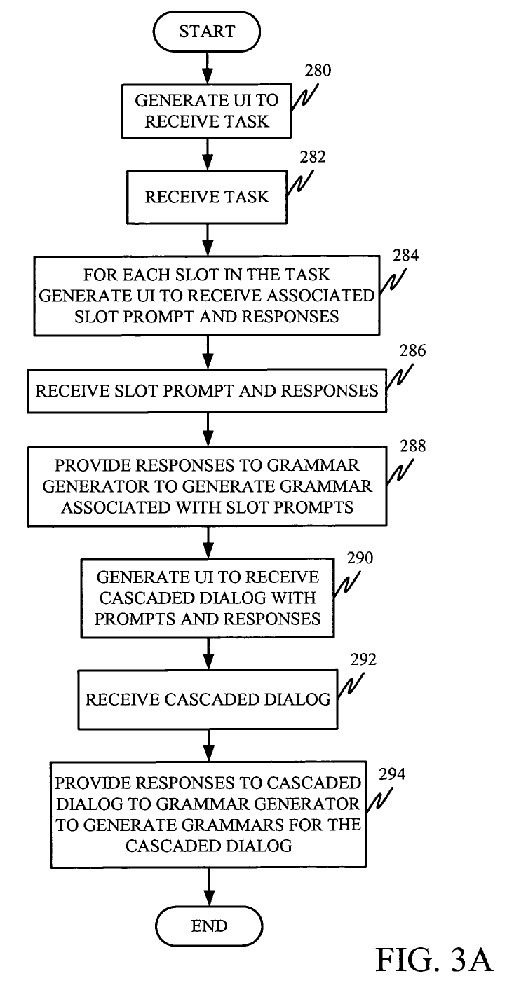

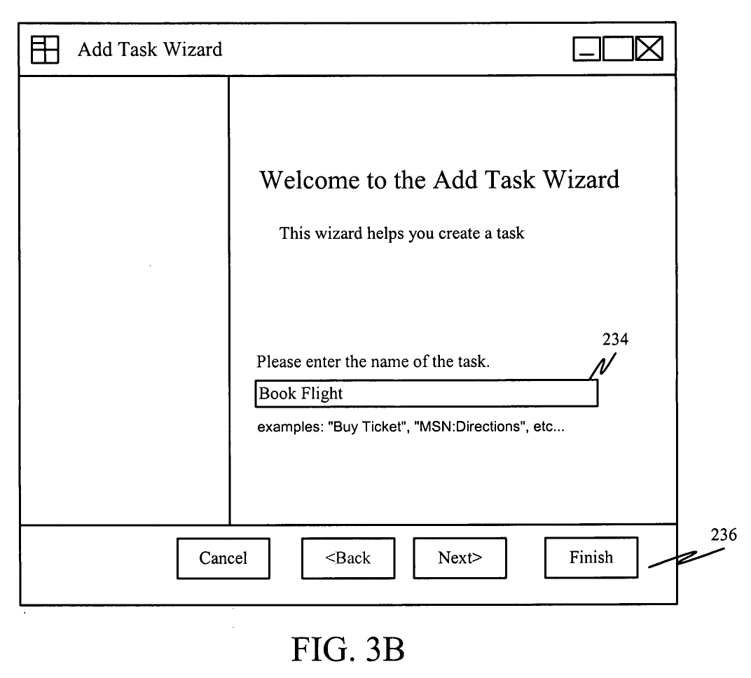

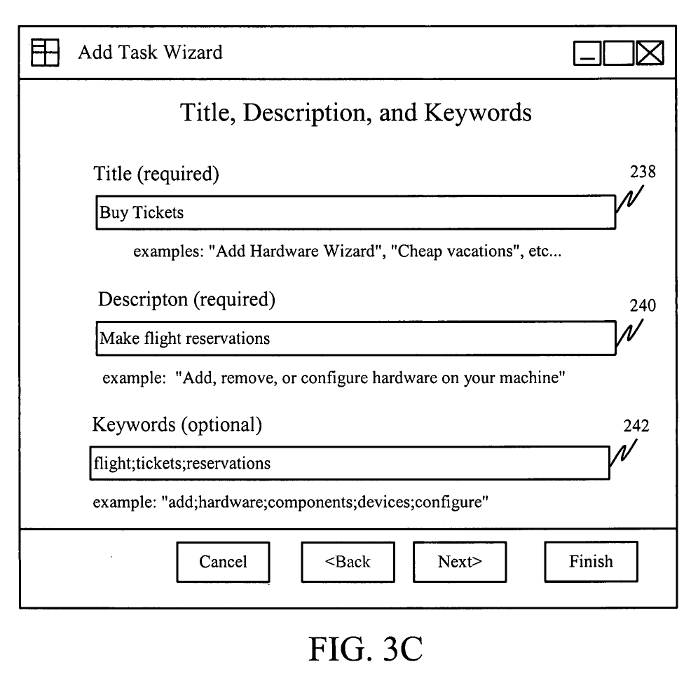

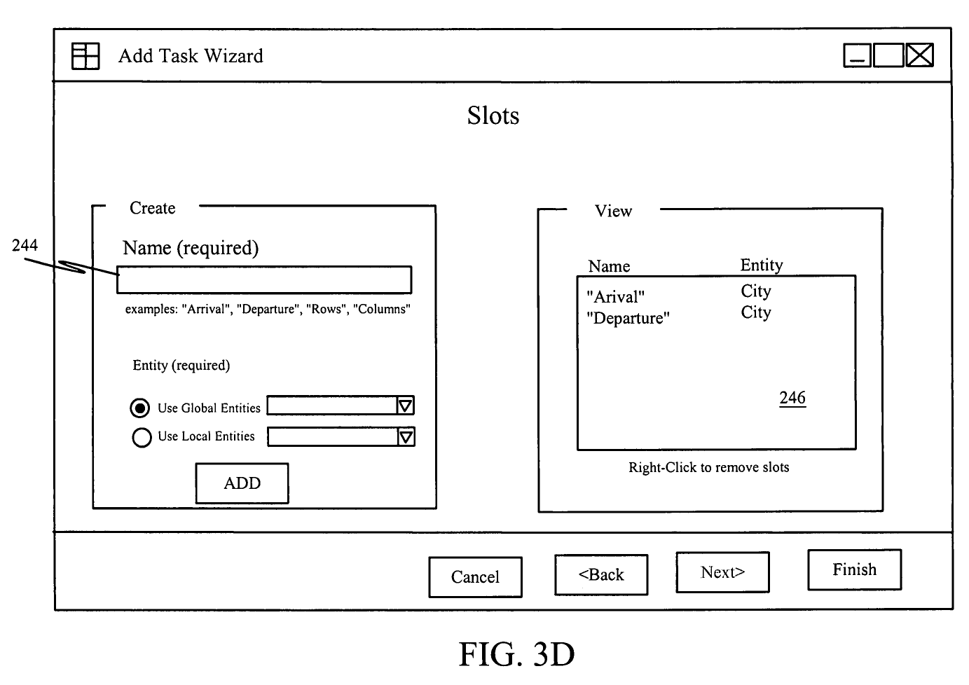

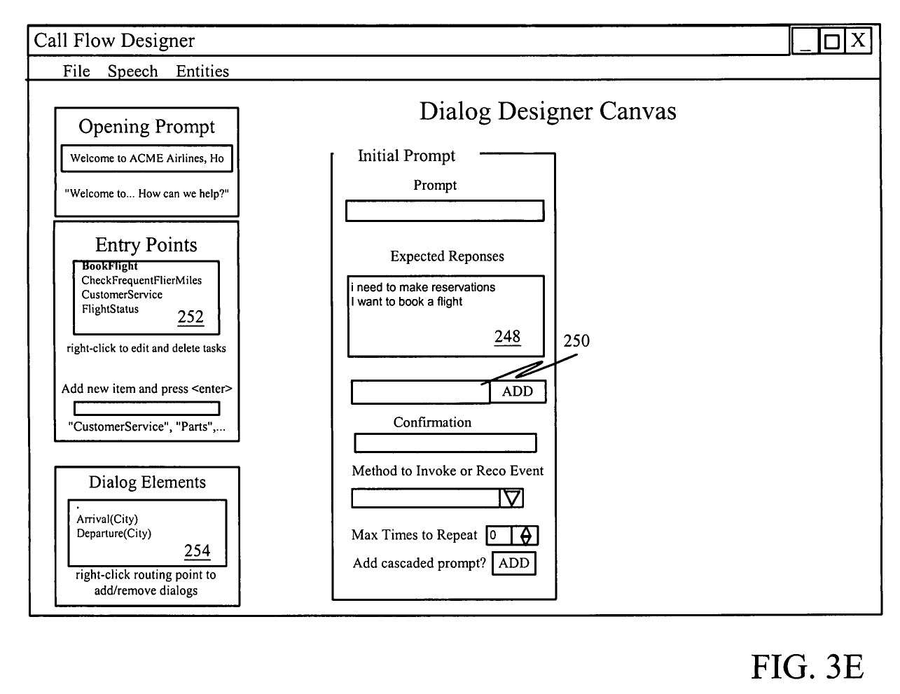

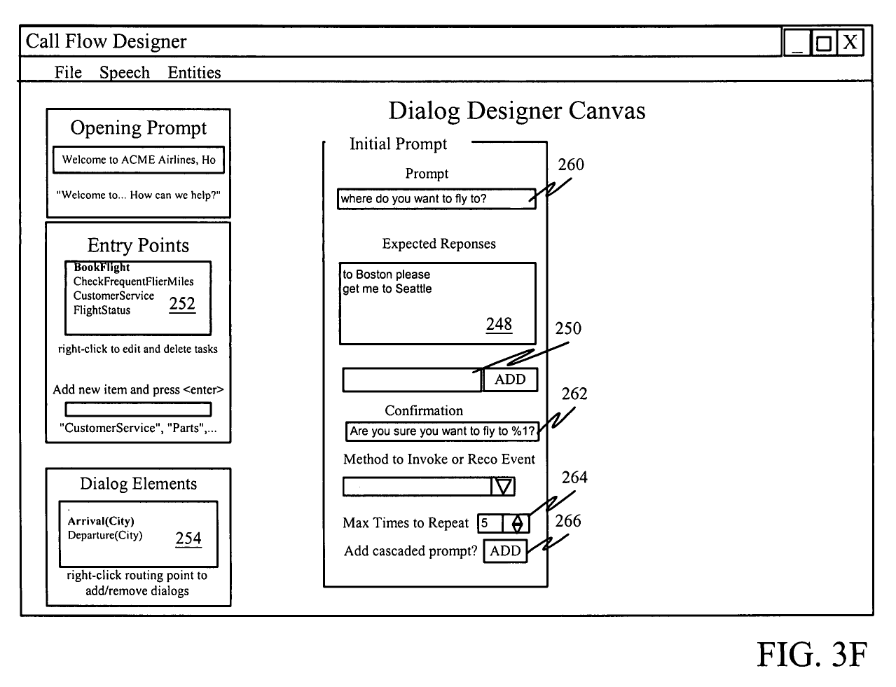

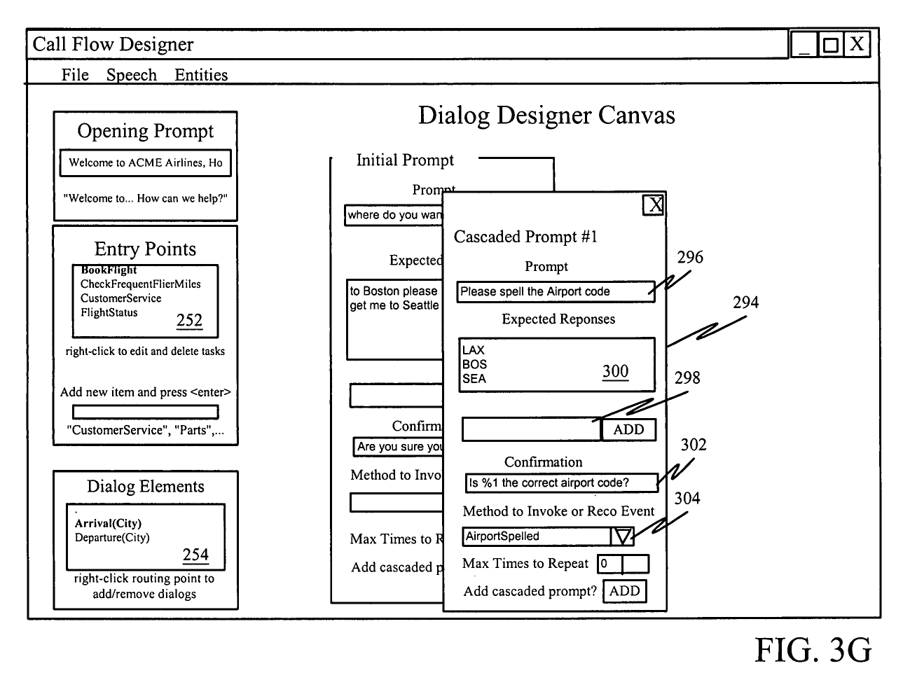

FIG. 3A is a flow diagram illustrating one exemplary embodiment in which a task is defined by an author. First, authoring component 112 generates a suitable authoring interface 116 to receive the task definition. This is indicated by block 230 in FIG. 3A. Authoring component 112 then receives information necessary to define the task as indicated by block 232.

FIG. 3B is one graphical illustration of an interface 116 that can be generated to receive the task information. The user interface shown in FIG. 3B illustratively includes a text box 234 that allows the user or author to type in the name of the task to be defined. The user interface also includes a plurality of buttons 236 that can be actuated to advance through the task definition process.

FIG. 3C is a user interface that provides text boxes 238, 240 and 242 that allow the user to specify certain parameters of the task. Those parameters shown in FIG. 3C include the title, the description, and the key words for the task.

FIG. 3D is a graphical illustration of an interface 116 that can be generated to allow a user to define slots in the task. In the embodiment shown in FIG. 3D, the name of the slots can be typed into a text field 244 and a global or local entity indicator can be selected. The graphical illustration shown in FIG. 3D also includes a view box 246 that allows the author to view the names and entities of slots that have been added to the task.

For each task thus identified, authoring component 112 provides an interface 116 that allows the author to specify excepted user responses that might be used to trigger selection of this task. FIG. 3E is a graphical illustration of a user interface that includes the expected user responses input by the author displayed in a display field 248. The expected user responses can illustratively be typed into a text box 250 and thus added to the display field 248 for the highlighted entry point in block 252. Thus, since the “book flight” entry point is highlighted, the expected responses that may trigger selection of the book flight task are “I need to make reservations” and “I want to book a flight”.

It will also be noted that dialog elements box 254 displays the dialog elements (or slots) associated with the highlighted task. In the present example, the two slots in the “book flight” task are the arrival city and the departure city. In the illustrative embodiment, authoring component 112 provides authoring interface 116 that allows the user to input a prompt associated with each slot and expected responses to that prompt. At runtime, the prompt is given to a user to solicit a response to fill the slot associated with the prompt. This is indicated by block 234 in FIG. 3A.

FIG. 3F shows one graphical illustration of a user interface in which a text box 260 is provided such that the user can type in the prompt associated with a highlighted element (or slot) highlighted in field 254. The expected responses to that prompt can again be entered in text box 250 so that they are added to the expected response display in field 248.

In the example shown in FIG. 3F, it can be seen that for the “arrival city” slot, the prompt is “Where do you want to fly to?”. The expected responses listed thus far are “To Boston please” and “Get me to Seattle”.

Before proceeding with the present description, it will simply be noted that FIG. 3F also shows that a slot can have a corresponding confirmation which can be typed into text box 262. The confirmation simply allows an application to have a user, at runtime, confirm that a recognized value for a slot is the correct value. FIG. 3F also shows that the author may also input a number of times, in box 264, that the slot prompt will be presented to the user before the user is routed to a live operator or to a cascaded dialog which is discussed in greater detail below.

In any case, receiving the slot prompt and responses is indicated by block 286. Authoring component 112 can then provide the expected responses to grammar generator 104 where the grammars can be generated for those expected responses. Again, however, it will be noted that the grammars simply need to be available when they are needed at runtime, and they can be generated anytime before then, using either the authoring component 112 or the runtime component 114.

Occasionally, a single dialog will not be adequate to obtain enough information to fill a particular slot (such as due to recognition errors, user uncertainty, or for other reasons). In that case, a developer may wish to extract the information from the user in a different way. For the sake of the present example, assume that the user was unable to properly specify an arrival city (or destination) but the user knew the airport code for the arrival city. In that instance, had the application developer provided a mechanism by which the user could select the destination city using the airport code, the application could have attempted to obtain that information in a different way than originally sought. For instance, if the developer had provided a mechanism by which the user could spell the airport code, that mechanism could be used to solicit information from the user instead of simply asking the user to speak the full destination city name.

Thus, in accordance with one embodiment, authoring component 112 generates a suitable authoring interface 116 to allow an author to specify a cascaded dialog, with prompts and responses. The cascaded dialog is simply an additional mechanism by which to seek the slot values associated with the task. Generating the UI to receive the cascaded dialog is indicated by block 290 in FIG. 3A and receiving the cascaded dialog is indicated by block 292.

Referring again to FIG. 3F, an “ADD” button 266 is provided to allow the author to add a cascaded dialog prompt. If the user actuates the “ADD” button 266, then a dialog box, such as box 294 shown in FIG. 3G, is presented by authoring component 112, to the author. It can be seen that dialog box 294 allows the user to specify a cascaded dialog prompt by typing it into text box 296. The author can also specify expected responses to the cascaded dialog prompt by typing them into text box 298 and clicking “ADD” in which case they are displayed in field 300. Dialog box 294 also allows the author to specify a slot confirmation by typing it in text box 302 and to bind to an external method by specifying that method in block 304.

By binding to an external method, it is meant that upon receiving an input in response to the cascaded dialog prompt in box 296, authoring component 112 can invoke a method external to component 102. In the exemplary embodiment shown in FIG. 3G, the method invoked is the “AirportSpelled” method in the speech recognizer. This is a method which is specifically geared to recognize spelled airport codes in the speech recognizer. Thus, during runtime, if the user was unable to specify the destination city by simply speaking the full city name, after attempting the threshold number of times (such as five times as shown in FIG. 3F) then the cascaded dialog is launched and the user is asked to spell the airport code, at which point the user can provide a spoken input spelling the airport code. That spoken input is provided to the “AirportSpelled” method in the speech recognizer for recognition.

In any case, once the expected responses to the cascaded dialog prompt 296 are provided by the author, authoring component 112 can provide those responses to the grammar generator 104 where the grammar can be generated. Again, it will be noted that the grammar simply needs to be generated prior to it being needed in the cascaded dialog during runtime. Providing the responses to the grammar generator and generating the grammars is indicated by block 294 in FIG. 3A.

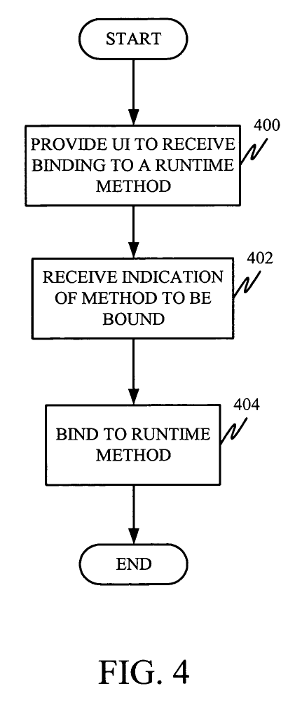

FIG. 4 is a flow diagram which explicitly sets out binding to an external method. In the embodiment shown in FIG. 4, authoring component 112 illustratively generates a suitable interface 116 to allow the user to specify the method which is to be invoked (i.e., which is being bound). This is indicated by block 400 in FIG. 4. Receiving the indicating of the method to be bound is indicated by block 402, and binding to the runtime method specified is indicated by block 404. An example of each of these items is shown and discussed above with respect to FIG. 3G.

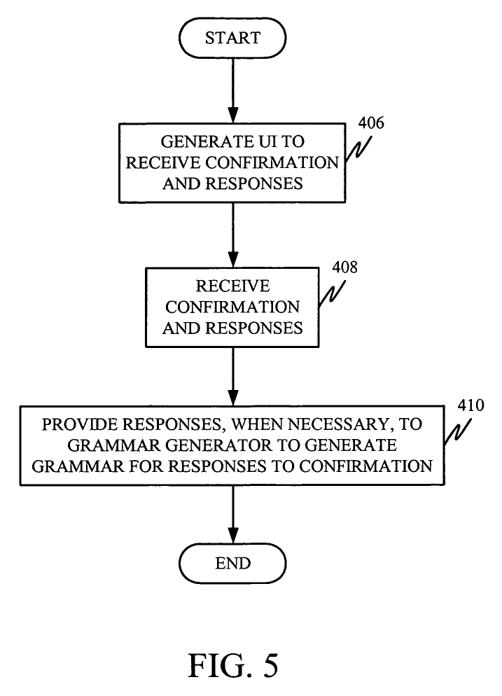

FIG. 5 explicitly sets out exemplary steps for providing confirmations to any of the values sought in the application. In one exemplary embodiment, authoring component 112 simply generates a user interface configured to receive the confirmation and expected responses to the confirmation. This is indicated by block 406. Receiving the confirmation and expected responses is indicated by block 408, and providing any responses, when necessary, to grammar generator 104 to generate the grammar for the expected responses to the confirmations is indicated by block 410.

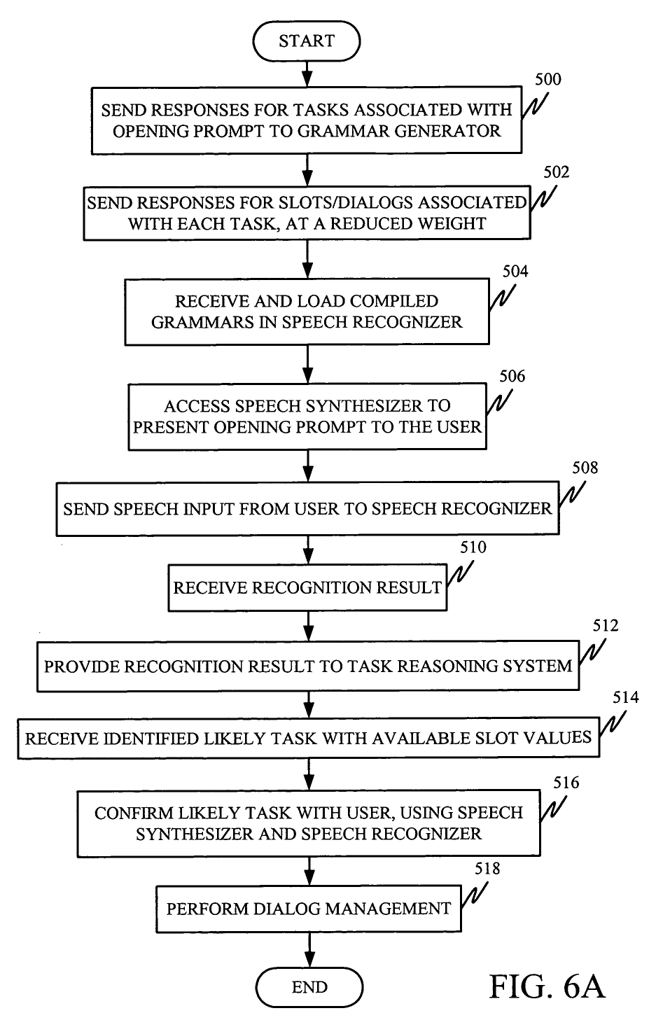

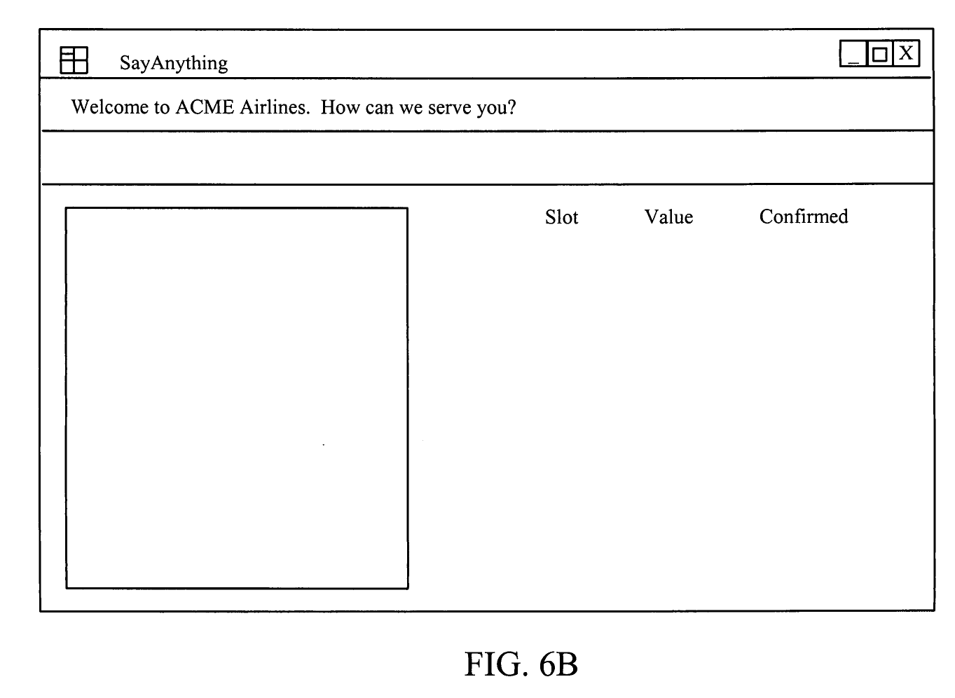

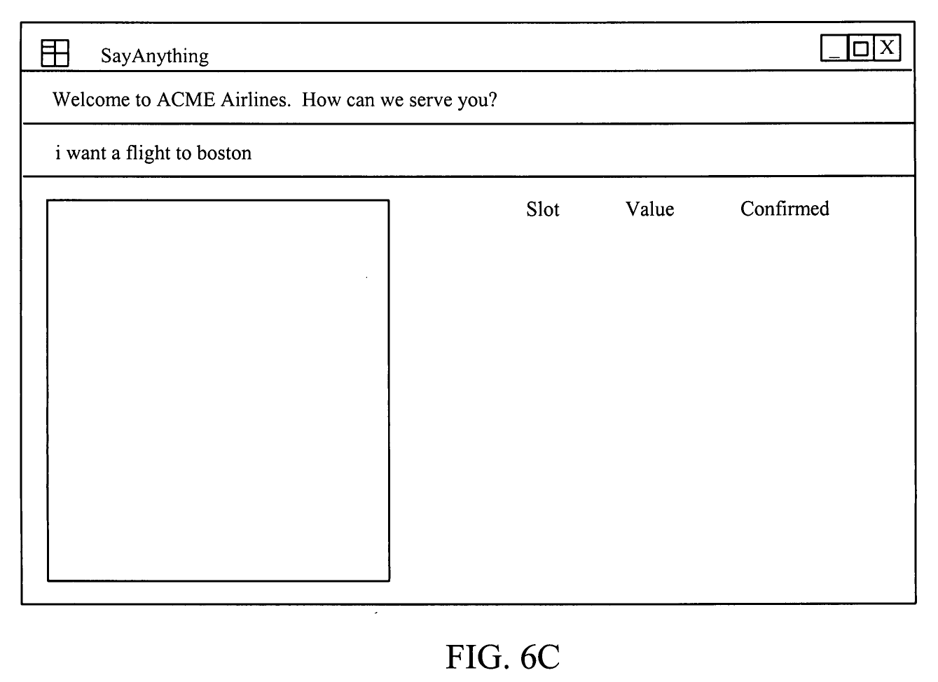

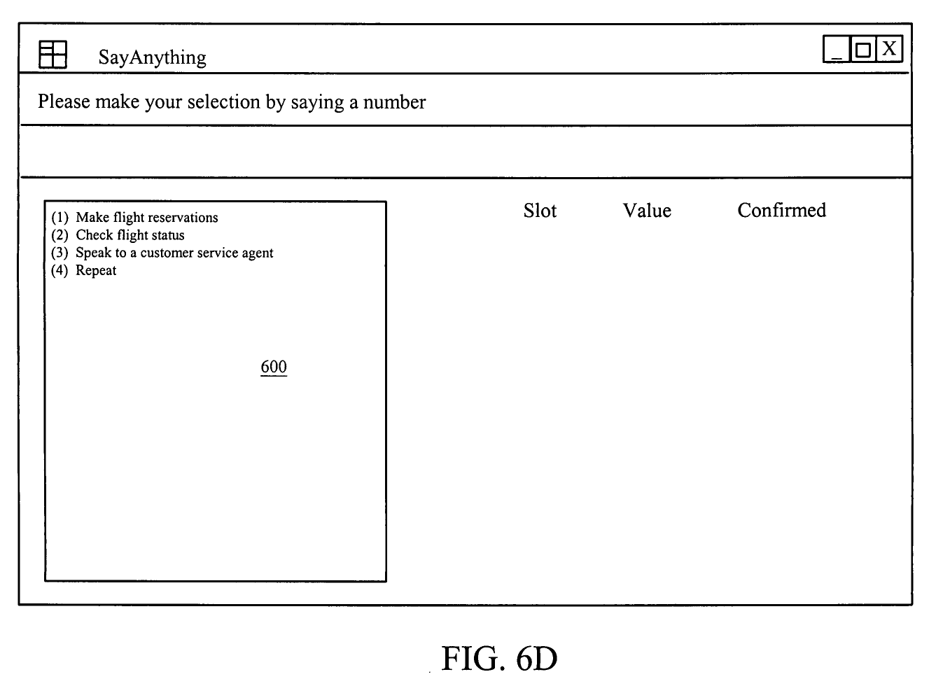

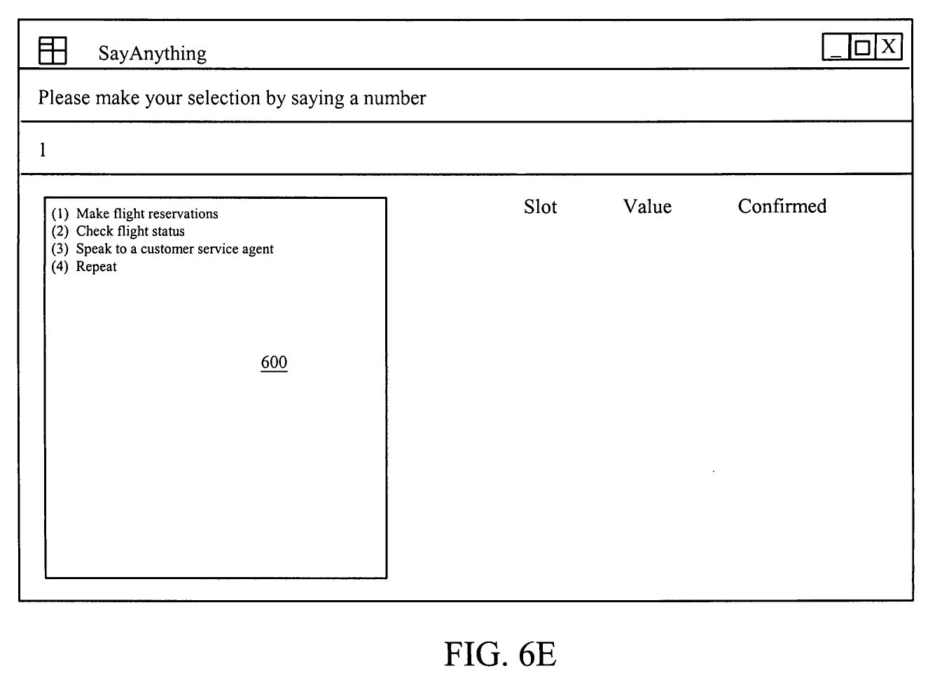

FIG. 6A is a flow diagram illustrating one illustrative embodiment of runtime operation of system 100 shown in FIG. 1. Runtime component 114 first identifies the opening prompt to be presented to the user.

Runtime component 114 then sends the expected responses for the tasks associated with the opening prompt to grammar generator 104. This is indicated by block 500 in FIG. 6A. Runtime component 114 also illustratively sends responses for the slots and dialogs associated with each task, at a reduced weight. This is indicated by block 502. This allows users to answer subquestions at the opening prompt, and thereby to fill out additional slots in the tasks, even where the user has not yet been expressly asked to fill those slots.

Grammar generator 104 compiles the grammars associated with the information provided to it, and those grammars are provided back to runtime component 114 where they are loaded into speech recognizer 106. Receiving and loading the complied grammars is indicated by block 504 in FIG. 6A.

In the exemplary embodiment being discussed, all prompts presented to the user are presented as audio prompts over a telephone, although this need not always be the case and prompts can be provided in other desired ways as well. Therefore, in the present example, the opening prompt is sent to speech synthesizer 108 where an audio representation of the prompt is generated and the audio representation is sent to runtime component 114, which sends the audio representation over a runtime user interface 124, to the runtime application or user using the application. This can be done over a telephone. This is indicated by block 506 in FIG. 6A.

The user then provides a spoken input in response to the opening prompt. That speech is received by runtime component 114 and sent to speech recognizer 106, which has had the desired grammars compiled and loaded into it. This is indicated by block 508 in FIG. 6A. The speech recognizer 106 then generates a recognition result and transfers it to runtime component 114. This is indicated by block 510. The recognition result is then provided to task reasoning system 130, as indicated by block 512.

FIG. 6B is a graphical illustration of the audio prompt that is provided to the user. It can be seen that the opening prompt is “Welcome to ACME Airlines. How can we serve you?”.

FIG. 6C shows a graphical illustration of the recognized speech input from the user. FIG. 6C shows that the user has responded “I want a flight to Boston”. In one embodiment, the recognition result is actually a word lattice which is sent back to runtime component 114.

Once task reasoning system 130 has received the speech recognition result, it performs task routing by selecting the most appropriate task given the speech recognition input. Task reasoning system 130 also makes a best guess at filling slots in the identified task. A list of the N most likely tasks, along with filled slots (to the extent they can be filled) is provided back from task reasoning system 130 back to runtime component 114. Runtime component 114 presents those likely tasks to the user through runtime interface 124. They are presented back to the user such that the user can either select or confirm which task the user wishes to perform. FIG. 6D is a graphical illustration of a list of tasks in field 600 which will be presented to the user, illustratively by synthesizing those tasks into audible speech and playing that audible speech to the user. Receiving the identified likely tasks from task reasoning system 130, along with the slot values, is indicated by block 514 in FIG. 6A, and presenting those tasks for confirmation by the user is indicated by block 516.

In response, the user selects one of the likely tasks presented to it. A graphical illustration of this is shown in FIG. 6E. Illustratively, however, the user will select the desired task by saying one of the numbers associated with the tasks. In the exemplary embodiment, the user has said the number “one” (which is provided to, and recognized by, the speech recognizer 108) and thus selected the “Make flight reservations” task.

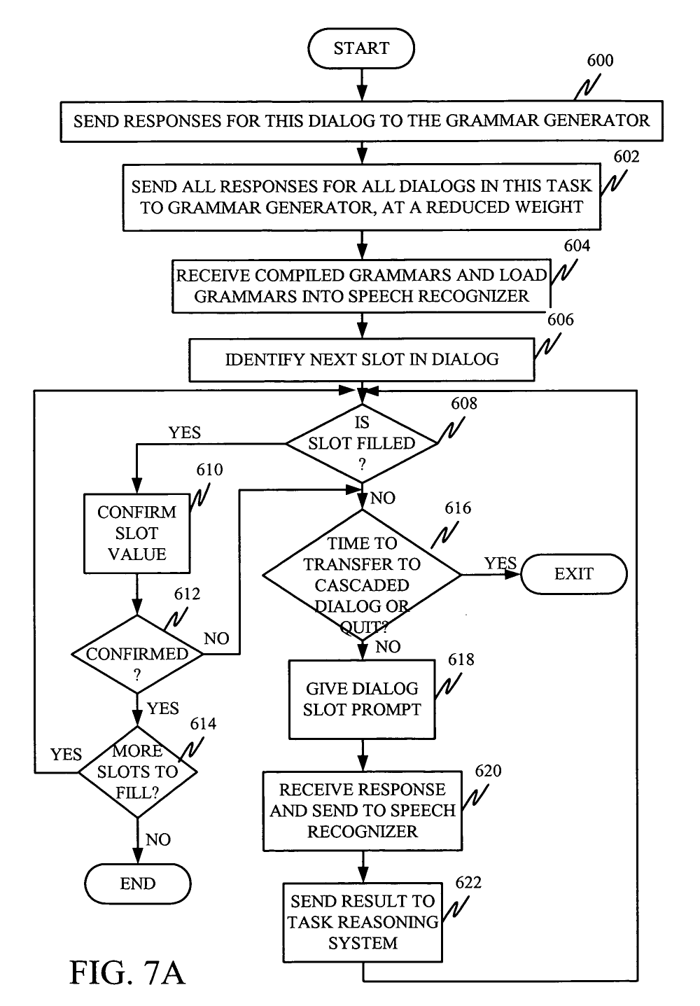

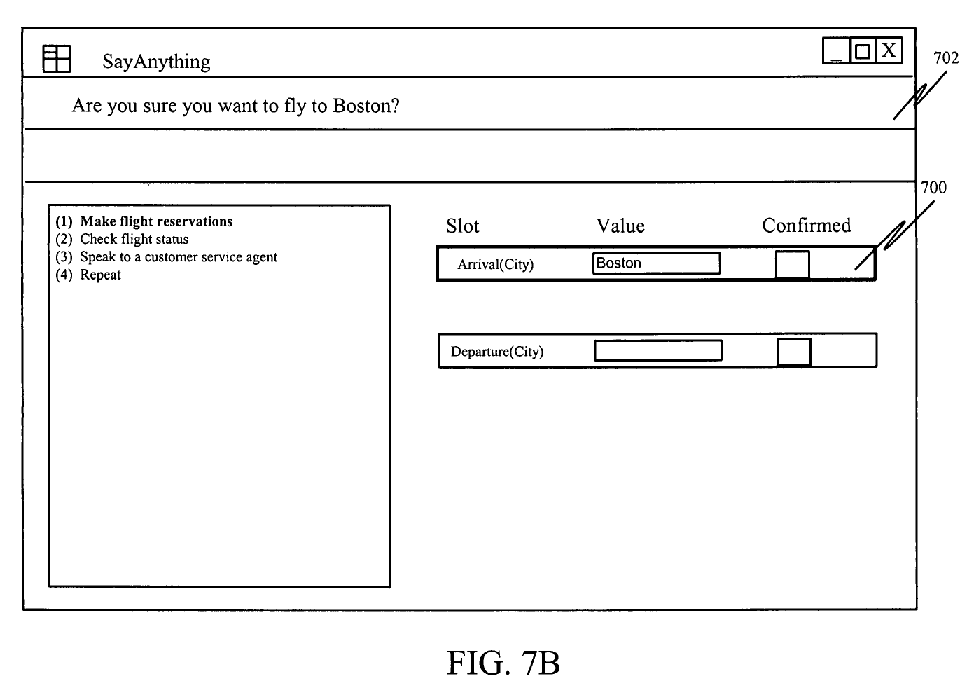

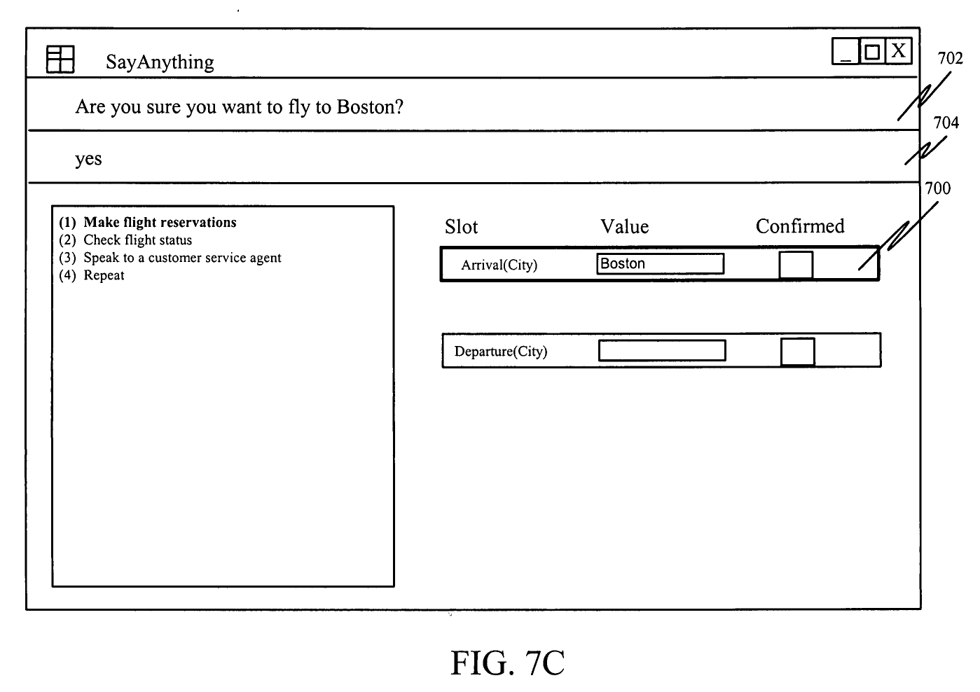

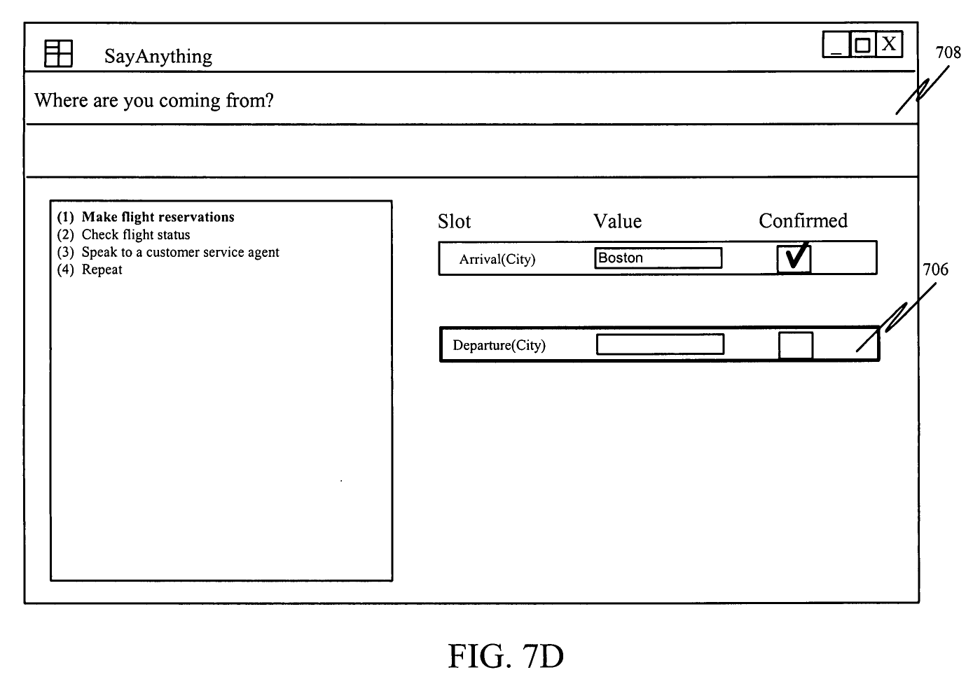

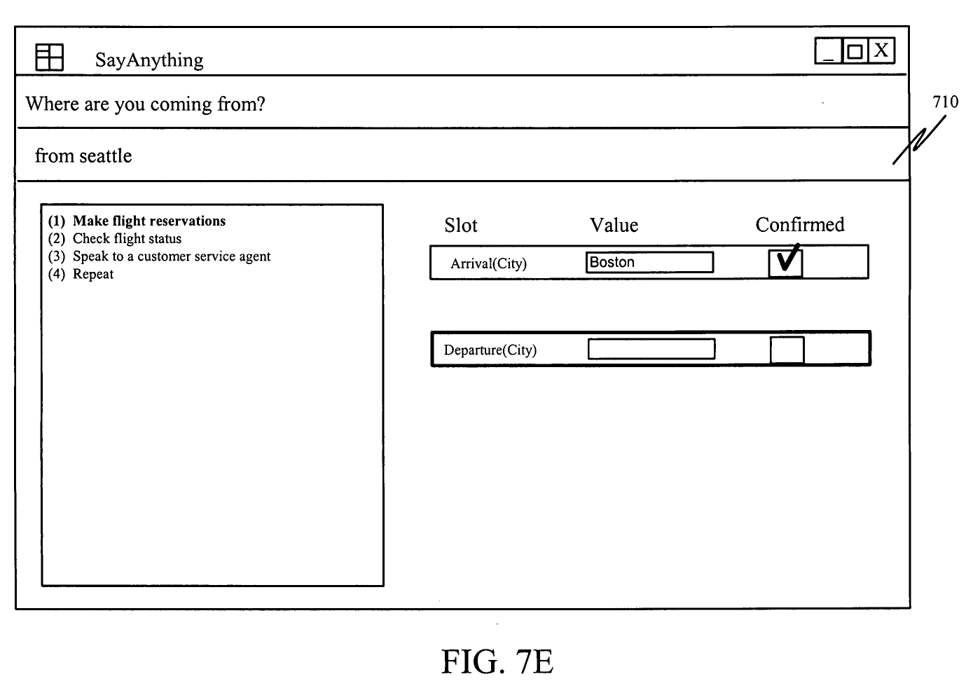

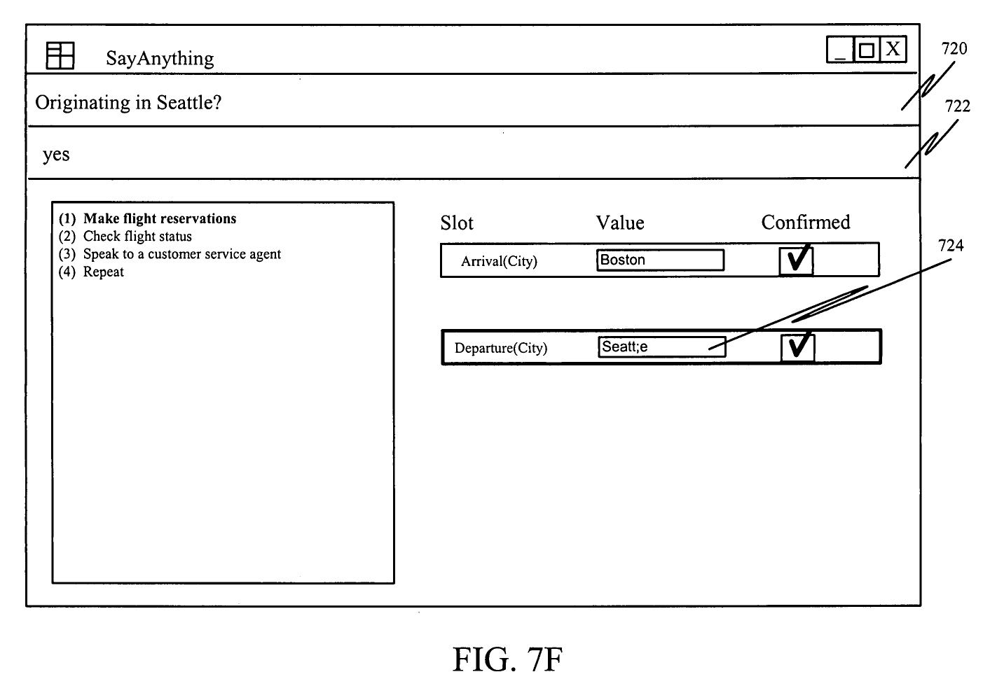

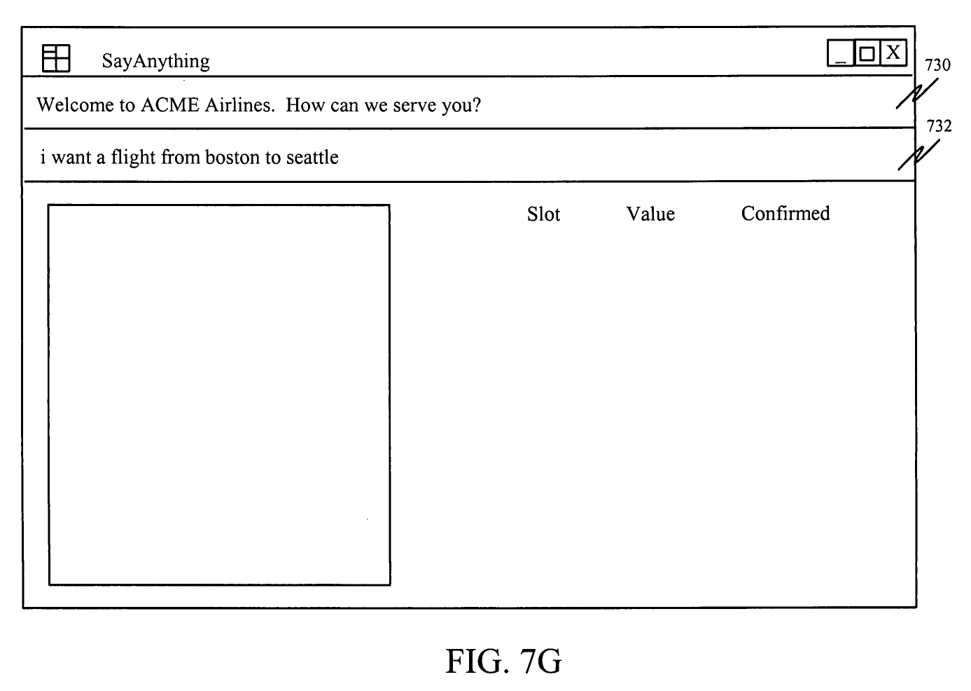

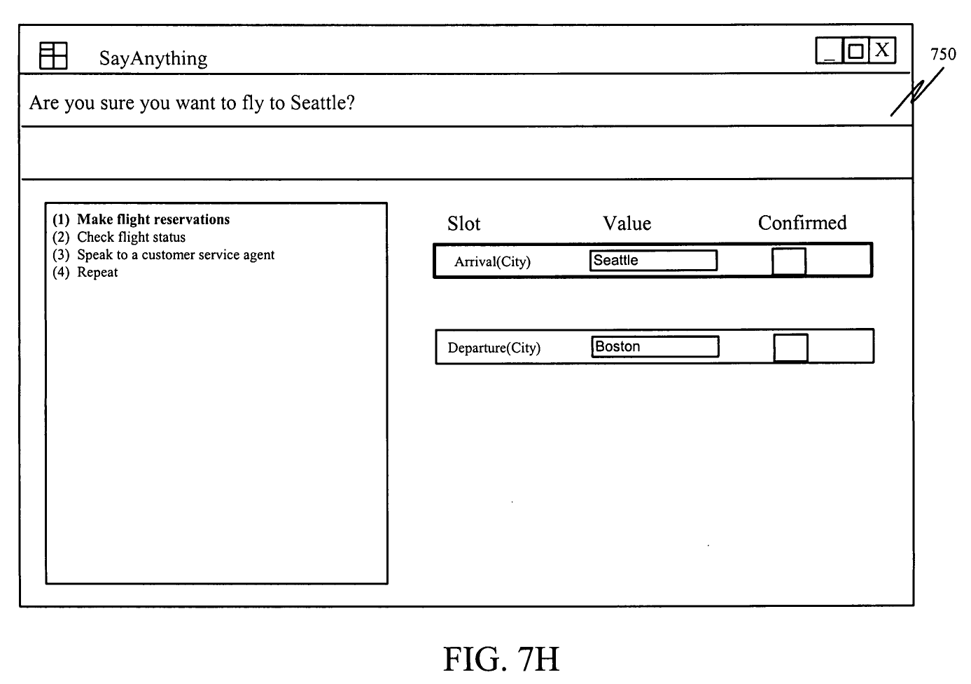

The confirmed task, along with its slot values, are presented back to task reasoning system 130 which performs dialog management in order to fully perform the task, if possible. Performing dialog management is indicated by block 518 in FIG. 6A and is described in greater detail below with respect to FIGS. 7A-7H. Briefly, for instance, once a task has been identified and confirmed, runtime component 114 conducts dialog management by accessing task reasoning system 130, to fill the various slots in the task such that the task can be completed.

Therefore, once the task has been identified, runtime component 114 sends the responses for the dialog (e.g., display responses to the slot prompts) associated with the task to the grammar generator 104 such that the grammar rules can be generated and compiled and loaded into speech recognizer 106. This is indicated by block 600 in FIG. 7A. Runtime component 114 also sends all of the responses for all of dialogs in this task to grammar generator 104, but at a reduced weight. This allows the user to answer multiple slots in the task within one utterance, even though the user is not yet specifically being asked for all of those slot values. This is indicated by block 602 in FIG. 7A. Next, grammar generator 104 compiles the grammars and provides them back to runtime component 114, which loads them into speech recognizer 106. This is indicated by block 604 in FIG. 7A.

The slots in an identified task are filled in the order in which they appear in the identified task. By accessing task reasoning system 130, runtime component 114 identifies a next slot to be filled in the dialog. This is indicated by block 606. Component 114 determines whether that slot is filled, at block 608. If the slot has already been filled, then component 114 confirms the slot value that is currently filling that slot. This is indicated by block 610. Component 114 does this by generating an interface 124 (such as an audio prompt) that can be played to the user to confirm the slot value.

FIG. 7B is a graphical illustration of one such user interface. In FIG. 7B, the slot name that is being confirmed is the arrival city, and the current value for that slot is “Boston”. This is shown in box 700 in FIG. 7B. In order to confirm the slot value, component 114 plays an audio confirmation prompt “Are you sure you want to fly to Boston?” as shown graphically in box 702 in FIG. 7B. The user then enters a confirmation value by simply saying “yes” or “no” or another response.

In the exemplary embodiment shown in FIG. 7C, the user has answered “yes” and this is graphically shown in box 704 in FIG. 7C. Therefore, once the user answers the confirmation prompt, runtime component 114 determines whether the user has confirmed the value by providing the user's input to speech recognizer 106 and returning the result to task reasoning system 130.

If it is determined that the user has confirmed the result, at block 612 in FIG. 7A, then component 114 determines whether there are more slots to be filled. This is indicated by block 614. If so, processing reverts back to block 606 where component 114 identifies a next slot in the dialog.

If, at block 608 the slot currently being processed is not filled, or if at block 612 it was filled with the wrong value (which is not confirmed) then processing continues at block 616, where runtime component 114 determines whether it is time to transfer the user to a cascaded dialog or to quit the system and transfer the user to a live operator. Thus, at block 616, runtime component 114 determines whether the slot prompt for the current slot being processed has been provided to the user the threshold number of times (such as five times indicated in FIG. 3F). If so, and the user has still not been able to enter the appropriate value, then runtime component 114 exits the current routine and either begins a cascaded dialog (which is processed as any dialog), or transfers the user to a live operator.

However, if, at block 616, component 114 determines that the threshold number of values has not been reached, then component 114 retrieves the dialog slot prompt, provides it to speech synthesizer 108, and plays it for the user. This is indicated by block 618 in FIG. 7A. FIG. 7D is a graphical illustration of this. It is first worth pointing out that FIG. 7D shows that the “arrival city” slot which was previously processed has the confirmed value “Boston”. It can also be seen in FIG. 7D that the current slot being processed is the “departure city” slot as shown in field 706. The slot prompt played for the user is “Where are you coming from?” as shown in field 708.

The user then responds to the slot prompt shown in field 708 by providing a spoken input which is provided from runtime component 114 to speech recognizer 106 where it is recognized and provided back to task reasoning system 130 through runtime component 114. Receiving and recognizing the user's response to the slot prompt is indicated by block 620 in FIG. 7A. Providing the result to the task reasoning system 130 is indicated by block 622 in FIG. 7A.

FIG. 7E is a graphical illustration indicating that the user has spoken “from Seattle” in response to the slot prompt. This is shown in field 710 in FIG. 7E. FIG. 7F shows that the origination city of “Seattle” is confirmed. In particular, processing reverted back to block 608 in FIG. 7A where runtime component 114 determined that the slot was filled and advanced to block 610 where runtime component 114 confirmed the value of the slot with the user by asking the user a confirmation prompt “Originating in Seattle?” as shown in field 720, and receiving the user's response “yes” as indicated in field 722. FIG. 7F shows that the “departure city” now has the confirmed slot value “Seattle” as shown in field 724.

Having no more slots to fill in this particular task (as determined in block 614 in FIG. 7A) the task has been completed, and processing moves on to the next task or whatever else is determined by the dialog management being performed in conjunction with task reasoning system 130.

FIGS. 7G and 7H better illustrate an embodiment in which the user fills multiple slots in response to the original prompt. For example, FIG. 7F shows a graphical illustration in which the original prompt “Welcome to ACME Airlines. How can we serve you?” is played to the user. This is illustrated by field 730 in FIG. 7E. The user responds “I want to fly from Boston to Seattle”, as indicated in field 732.

FIG. 7H shows that the system advances directly to the confirmation stage, because both slots “arrival city” and “departure city” have already been assigned at least preliminary values. Therefore, the system begins by confirming the arrival city, by asking the user “Are you sure you want to fly to Seattle?”, as shown in field 750. If the user responds “yes” then that slot value is confirmed and the system goes on to confirm the “departure city” slot value as well.

It will also be noted that the present system can provide advantages in training. For instance, whenever the user confirms a value, this information can be used to train both the semantic subsystems and the speech subsystems. Specifically, when the user confirms a spoken value, the transcription of the spoken value and its acoustic signal can be used to train the acoustic models in the speech recognizer. Similarly, when the user confirms a series of words, that series of words can be used to train the language models in the speech recognizer.

The confirmed inputs can also be used to train the semantic systems. For instance, the confirmed inputs can be used to identify various values that are acceptable inputs in response to prompts, or to fill slots. Thus, the spoken inputs can be used to train both the speech and semantic systems, and the confirmation values can be used to train both systems as well.

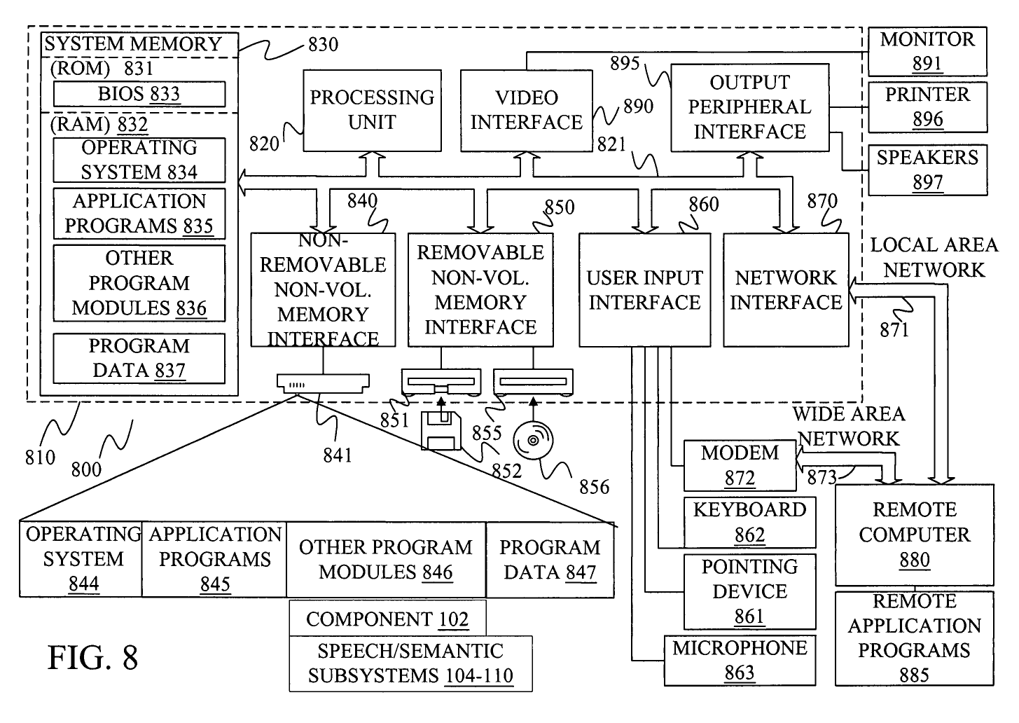

The present invention can, of course, be practiced on substantially any computer. The system can be practiced in a client environment, a server environment, a personal computer or desktop computer environment, a mobile device environment or any of a wide variety of other environments. FIG. 8 shows but one exemplary environment in which the present invention can be used, and the invention is not to be so limited.

FIG. 8 illustrates an example of a suitable computing system environment 800 on which embodiments may be implemented. The computing system environment 800 is only one example of a suitable computing environment and is not intended to suggest any limitation as to the scope of use or functionality of the claimed subject matter. Neither should the computing environment 800 be interpreted as having any dependency or requirement relating to any one or combination of components illustrated in the exemplary operating environment 800.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 8, an exemplary system for implementing some embodiments includes a general-purpose computing device in the form of a computer 810. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures.

Computer 810 typically includes a variety of computer readable media. Computer readable media can be any available media that can be accessed by computer 810 and includes both volatile and nonvolatile media, removable and non-removable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable volatile/nonvolatile computer storage media. By way of example only, FIG. 8 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media can also be used. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 8, provide storage of computer readable instructions, data structures, program modules and other data for the computer 810. In FIG. 8, for example, hard disk drive 841 is illustrated as storing operating system 844, application programs 845, other program modules 846 (which is where component 120 and subsystem 104-110 are shown, although they can be stored in other memory as well), and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. These and other input devices are often connected to the processing unit 820 through a user input interface 160 that is coupled to the system bus, but may be connected by other interface and bus structures, such as a parallel port, game port or a universal serial bus (USB). A monitor 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 can be operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 8 illustrates remote application programs 885 as residing on remote computer 880. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system for authoring and running a speech related application, comprising:
a speech related subsystem configured to perform speech related functions for authoring and running the speech related application;
a semantic subsystem, separate from the speech related subsystem, configured to perform semantic functions for authoring and running the speech related application; and
a semantics and speech component, coupled to the speech related subsystem, the semantic subsystem, including:
an authoring component configured to generate an authoring user interface to receive authoring inputs indicative of desired portions of the speech related application and configured to interact with the speech related subsystem and the semantic subsystem to perform authoring steps on those subsystems to generate the desired portions of the speech related application based on the authoring inputs; and
a runtime component configured to generate a runtime user interface to receive user inputs during runtime of the speech related application and configured to interact with the speech related subsystem and the semantic subsystem to perform application functions on those subsystems based on the user inputs.

2. The system of claim 1 wherein the authoring component is configured to generate a prompt user interface to receive prompts from the author.

3. The system of claim 2 wherein the authoring component is configured to generate a response user interface to receive likely responses to the prompt from the author.

4. The system of claim 3 wherein the speech related subsystem comprises a grammar generator and a speech recognizer and wherein the authoring component is configured to provide the likely responses to the grammar generator and to receive a grammar based on the likely responses that can be loaded into the speech recognizer for use during runtime of the speech related application.

5. The system of claim 4 wherein the semantic subsystem includes a task definition system and wherein the authoring component is configured to generate a task user interface to receive task authoring inputs indicative of a desired task to be defined and to interact with the task definition system to define the task for the speech related application.

6. The system of claim 5 wherein the authoring component is configured to generate a slot user interface to receive a slot prompt and likely responses to the slot prompt for each semantic slot in the defined task.

7. The system of claim 6 wherein the authoring component is configured to provide the likely responses to the slot prompt to the grammar generator and to receive a grammar based on the likely responses to the slot prompt that can be loaded into the speech recognizer for use during runtime of the speech related application.

8. The system of claim 6 wherein the authoring component is configured to generate a cascaded dialog user interface to receive authoring inputs indicative of a desired cascaded dialog and to interact with the task definition system to define the cascaded dialog for the speech related application.

9. The system of claim 1 wherein the authoring component is configured to generate a binding user interface to receive an authoring input indicative of a desired method, external to the semantics and speech component, to be bound to a portion of the speech related application so the method is invoked at that portion of the speech related application.

10. The system of claim 1 wherein the authored speech related application includes prompts, likely responses to the prompts, tasks, and slots associated with the tasks and wherein the speech subsystem includes a grammar generator and wherein the runtime component is configured to send the likely responses to the prompts and likely responses to dialog prompts for filling the slots to the grammar generator and to receive a generated grammar from the grammar generator.

11. The system of claim 1 wherein the speech subsystem includes a speech recognizer and wherein the runtime component is configured to load the generated grammar into the speech recognizer.

12. The system of claim 11 wherein the speech subsystem includes a speech synthesizer and wherein the runtime component is configured to generate the runtime user interface by accessing the speech synthesizer and playing one or more of the prompts and dialog prompts for the user.

13. The system of claim 12 wherein the runtime component is configured to receive a speech input in response to the prompts and dialog prompts and to access the speech recognizer to obtain a recognition of the speech input.

14. The system of claim 13 wherein the semantic subsystem includes a task reasoning system and wherein the runtime component is configured to interact with the task reasoning system to manage one or more dialogs in the speech related application based on the recognition of the speech input.

15. The system of claim 14 wherein the runtime component manages the one or more dialogs by interacting with the task reasoning system to identify desired tasks based in the recognition of the speech input and conducting the one or more dialogs to fill slots in the desired tasks.

16. A method of authoring a speech related application, comprising:
generating, at a speech and semantic component, a plurality of authoring user interfaces configured to receive authoring inputs to define tasks to be performed by the speech related application, the tasks requiring actions by both a speech subsystem and a separate semantics subsystem; and
conducting, with the speech and semantic component, interactions with the speech subsystem and the semantics subsystem, independently of the user, to define the tasks for the speech related application, the interactions being independent of express specification of the interactions by the user.

18. The method of claim 16 wherein the interactions comprise:
accessing a grammar generator to generate one or more grammars; and
interacting with a semantic framework to define one or more tasks and dialogs.

19. A method of running a speech related application, comprising:
generating, at a single speech and semantic component, a user interface configured to receive a user input indicative of a desired task in the speech related application to be performed, the task requiring processing by both a speech subsystem and a separate semantics subsystem; and
conducting, with the single speech and semantic component, interactions, not expressly specified by the user, with the speech subsystem and the semantics subsystem, to perform the desired task.

20. The method of claim 19 wherein the interactions comprise:
providing speech inputs to a speech recognizer to recognize the speech inputs; and
accessing a semantic framework with the recognized speech inputs to manage a dialog for performing the desired task.
